(19) United States
(12) Patent Application Publication
(10) Pub. No.: US 2007/0173157 A1
(43) Pub. Date: Jul. 26, 2007

(54) FLEXIBLE COHERENT INSULATING STRUCTURES

(75) Inventors: Roxana Trifu, Worcester, MA (US); Nathan Bhobho, Dudley, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS, INC., Northborough, MA (US)

(21) Appl. No.: 11/627,639

(22) Filed: Jan. 26, 2007

Related U.S. Application Data
(60) Provisional application No. 60/762,269, filed on Jan. 26, 2006.

(51) Int. Cl. B32B 27/12

(52) U.S. Cl. 442/286; 442/394

(57) ABSTRACT

Embodiments of the present invention involve an insulating structure comprising; at least one fibrous layer comprising a continuous matrix of an aerogel material infused therein, said at least one fibrous layer secured with an adhesive to a polymeric sheet. In some embodiments the structure may comprise a coating on at least one side of the fibrous layer. In some embodiments more than one side of the fibrous layer is secured with an adhesive to a polymeric sheet. Methods for preparing these structures are also described.

### CROSS-REFERENCES TO RELATED APPLICATIONS

This application claims benefit of priority to U.S. Provisional Patent Application Ser. No. 60/762,269 filed on Jan. 26, 2006 the contents of which is hereby incorporated by reference as if fully set forth.

### FIELD OF INVENTION

The invention relates to insulating structures comprising fiber-reinforced aerogels, and to methods for preparing the same.

### DESCRIPTION

Aerogels materials are excellent insulators due mainly to their low density and highly porous structure. Though often fragile, such structures may be reinforced to achieve improved mechanical performance while substantially maintaining the thermal insulating properties. Furthermore, aerogel materials may be incorporated into multi-layered structures wherein the structure overall is mechanically stable and thereby exhibiting added thermal performance. For instance, U.S. Pat. No. 6,544,618 describes aerogel particulates in a multilayered structure wherein the aerogel particles are not reinforced but co-adhered with a binder. Similarly, published US patent application 2003/0003284 describes aerogel particles mixed with fibers and a binder composition and maintained between covering layers. In an electronics-related application U.S. Pat. No. 6,740,416 teaches a multilayer structure comprising a functional layer and an aerogel layer and an intermediate layer formed there between wherein the aerogel layer is not reinforced. Finally U.S. Pat. No. 6,316,092 teaches an aerogel coating applied to a film wherein the aerogel coating may comprise fibers. Embodiments of the present invention describe novel insulating structures comprising fiber-reinforced aerogel materials and at least one polymeric sheet resulting in coherent structures. Such structures are highly flexible, durable and exhibit low thermal conductivity.

### SUMMARY OF THE INVENTION

Embodiments of the present invention involve an insulating structure comprising; at least one fibrous layer comprising a continuous matrix of an aerogel material infused therein, said at least one fibrous layer secured with an adhesive to a polymeric sheet. In some embodiments the structure may comprise a coating on at least one side of the fibrous layer. In some embodiments more than one side of the fibrous layer is secured with an adhesive to a polymeric sheet. Methods for preparing these structures are also described.

### DESCRIPTION OF FIGURES

FIG. 1 Illustrates an insulating structure wherein two sides of the fibrous layer is secured with an adhesive to a polymeric sheet.

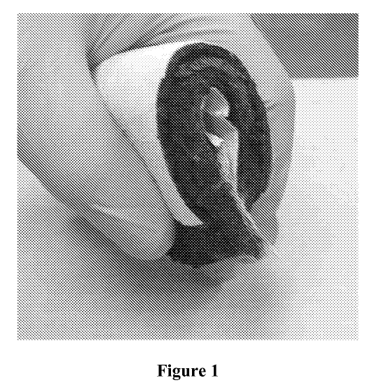

FIG. 2 Illustrates an insulating structure wherein one side of the fibrous layer is secured with an adhesive to a polymeric sheet and coated on the opposing side.

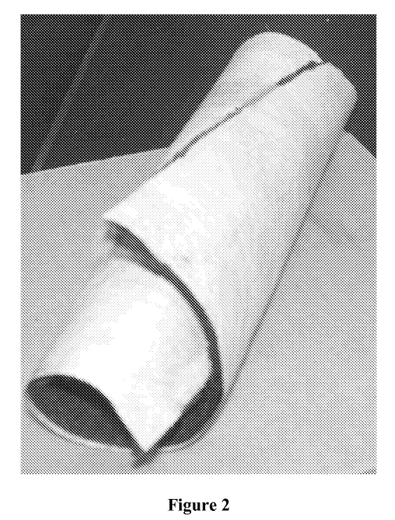

### DETAILED DESCRIPTION OF THE INVENTION

Within the context of embodiments of the present invention “aerogels” or “aerogel materials” along with their respective singular forms, refer to gels containing air as a dispersion medium in a broad sense, and include aerogels, xerogels and cryogels in a narrow sense. The chemical composition of aerogels can be inorganic, organic (including polymers) or hybrid organic-inorganic. Examples of inorganic aerogels include, but are not limited to silica, titania, zirconia, alumina, hafnia, yttria, ceria, carbides and nitrides. Organic aerogels can be based on compounds such as but are not limited to: urethanes, resorcinol formaldehydes, polyimide, polyacrylates, chitosan, polymethylmethacrylate, members of the acrylate family of oligomers, trialkoxysilyl terminated polydimethylsiloxane, polyoxyalkylene, polyurethane, polybutadiane, melamine-formaldehyde, phenol-furfural, a member of the polyether family of materials or combinations thereof. Examples of organic-inorganic hybrid aerogels include, but are not limited to: silica-PMMA, silica-chitosan, silica-polyurea or possibly a combination of the aforementioned organic and inorganic compounds. Published US patent applications 2005/0192367 and 2005/0192366 teach extensively of such hybrid organic-inorganic materials and are hereby incorporated by reference in their entirety.

Aerogels can be opacified with compounds such as but not limited to: B₄C, Diatomite, Manganese ferrite, MnO, NiO, SnO, Ag₂O, Bi₂O₃ , TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

In embodiments of the present invention, at least one fibrous layer is bonded to at least one polymeric sheet with an adhesive. The fibrous layer may comprise organic polymer-based fibers (e.g. polyethylenes, polypropylenes, polyacrylonitriles, polyamids, aramids, polyesters etc.) inorganic fibers (e.g. carbon, quartz, glass, etc.) or both and in forms of, wovens, non-wovens, mats, felts, battings, lofty battings, chopped fibers, or a combination thereof. Aerogel composites reinforced with a fibrous batting, herein referred to as “blankets”, are particularly useful for applications requiring flexibility since they can conform to three-dimensional surfaces and provide very low thermal conductivity. Aerogel blankets and similar fiber-reinforced aerogel composites are described in published US patent application 2002/0094426A1 and U.S. Pat. Nos. 6,068,882, 5,789,075, 5,306,555, 6,887,563, and 6,080,475, all hereby incorporated by reference, in their entirety. Some embodiments of the present invention utilize aerogel blankets, though similar aerogel composites (e.g. those disclosed by reference) may also be utilized.

Suitable polymeric sheets generally include all polymers that can be formed into a sheet. General examples include but are not limited to: polyesters, polyethylenes, polyurethanes, polypropylenes, polyacrylonitriles, polyamids, aramids, more specifically polymers such as polyethyleneterphthalate, low density polyethylene, ethylene-propylene co-polymers, poly(4-methyl-pentane), polytetrafluoroethylene, poly(1-butene), polystyrene, polyvinylacetatae, polyvinylchloride, polyvinylidenechloride, polyvinylfluoride, polyvinylacrylonitrile, plymethylmethacrylate, polyoxymethylene, polyphenylenesulfone, cellulosetriacetate, polycarbonate, polyethylene naphthalate, polycaprolactam, polyhexamethyleneadipamide, polyundecanoamide and polyimide. In a preferred embodiment Tyvek® is used as the polymeric sheet.

In general, adhesives suitable for securing the fibrous layer to the polymeric sheet include any that can bind inorganic or organic fibers to polymeric surfaces. Examples include but are not limited to: aerosol adhesives, urethane, acrylate adhesives, hot melt boding systems commercially available from 3M, as well as rubber resin adhesives. In one aspect of the present invention the adhesive for bonding the fibrous layer to the polymeric sheet does not comprise any aerogel material. Stated differently, the gel precursor solution is not used for bonding the fibrous layer to the polymeric sheet.

The fibrous layer in the insulating structures described comprises an aerogel material. In embodiments of the present invention, a solution comprising the gel precursor materials (i.e. the sol) is introduced into the fibrous layer where it is allowed to gel. Gel precursor solutions comprise precursor compounds for forming a gel material. In a preferred embodiment, the gel precursor solution comprises silica gel precursors. Specifically, hydrolyzed or partially hydrolyzed silicates or silicic acid and its derivatives. Preferably hydrolyzed or partially hydrolyzed ethylsilicates and/or ethylpolysilicates.

Gelling may be induced by adding a catalyst, changing the pH of the solution (i.e. adding base or acid), by applying heat or an electromagnetic energy (e.g. IR, UV, X-ray, microwave, gamma ray, acoustic energy, ultrasound energy, particle beam energy, electron beam energy, beta particle energy, alpha particle energy, etc), or a combination thereof. Gelling may be detected as an increased resistance to flowing, or an increase in viscosity in the gel precursor solution.

The resultant gel may be optionally aged, silylated, surface modified with groups such as isocyanates or surface esterified in order to improve the gel strength. Finally the gel is dried wherein the liquid phase in the porous structure is replaced with air. Accordingly in some embodiments of the present invention, an aerogel is formed in the insulating structure rather than preformed. That is, the aerogel (e.g. in granular or powder form) is not first prepared and then introduced in the insulating structure. In another aspect of some embodiments, the aerogel material is not in direct contact with the polymeric sheet. In this sense the adhesive bonds the fibrous layer to the polymeric sheet and resides between, the aerogel material and the sheet.

Aging including silylation, surface modification with groups such as isocyanates or surface esterification of gel materials may be carried out to strengthen the gel structure (“Aging”). In preferred embodiments, solutions comprising disilazanes, disiloxanes and ethanol are used at between about 30° C. to about 90° C. to carry out the Aging process.

Drying may be accomplished using a variety of methods known in the art. U.S. Pat. No. 6,670,402 herein incorporated by reference, teaches drying via rapid solvent exchange of solvent(s) inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 herein incorporated by reference, describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 herein incorporated by reference, discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 herein incorporated by reference describes a process whereby Resorcinol/Formaldehyde aerogels can be manufactured using a simple air drying procedure. Finally, U.S. Pat. No. 5,565,142 herein incorporated by reference describes subcritical drying techniques. The embodiments of the present invention can be practiced with drying using any of the above techniques. In some embodiments, it is preferred that the drying is performed at vacuum to below super-critical pressures (pressures below the critical pressure of the fluid present in the gel at some point) and optionally using surface modifying agents.

In an embodiment, the insulating structure comprises two polymeric sheets each with a fibrous layer affixed thereto. To form the aerogel in this structure, a gel precursor solution is poured into one fibrous layer, wherein the polymeric sheet is configured to contain the solution or is placed inside a container permitting the same. Preferably there is an excess of gel precursor solution above the fibrous layer such that the other fibrous layer may be pressed or otherwise placed in the excess solution. This may be achieved for example by a twin roller mechanism having a desired clearance there between, through which the fibrous layers with the gel precursor solution are conveyed. Of course there are many other pressing mechanisms that may be used for achieving the same objective including the techniques described in U.S. Pat. No. 6,989,123. Subsequently the gel precursor solution is gelled within both fibrous layers, thereby securing both. Optionally an Aging step is carried out. After drying (e.g. supercritical extraction) the aerogel remains as a continuous material between the polymeric sheets. In some embodiments, the final structure may have engineered cracks that facilitate flexibility. The final structure may comprise an aerogel material infused into both fibrous layers. In some cases the thickness of the fiber layer interpenetrated with the gel precursor solution is larger than the “thickness” of the excess gel precursor solution. In some other cases, thickness of the fiber layer interpenetrated with the gel precursor solution is smaller than the “thickness” of the excess gel precursor solution.

In another embodiment, a fibrous layer is affixed to a polymeric sheet and wherein a gel precursor solution is poured into the fibrous layer. The polymeric sheet is configured to contain the solution or is placed inside a container permitting the same. Optionally the fibrous layer is coated. Once the gelling takes place, aging (optional) and drying can be carried out to obtain the final structure.

In one embodiment, the polymeric sheet contains holes with diameters large enough to allow fluids to diffuse through. As such, number distribution, and pattern is also of importance. This is advantageous for the aging process, since the aging fluid more easily enters the gel material. Likewise, this arrangement also can facilitate the drying process. Preferably, holes are placed in polymeric sheets after the gel is formed, but before drying and/or aging. More preferably the holes also penetrate the adhesive or adhesive layer.

In some embodiments the fibrous layer is coated on at least one side with a material suitable for reasons such as, but not limited to reducing dust generation. Dusting essentially refers to flaking of aerogel particles. A suitable coating preferably forms a cohesive layer on the surface of the aerogels thereby reducing dust generation. Suitable coatings include, but are not limited to materials comprising silicones, polyorganosiloxanes, polyurethanes, acrylics or a combination thereof. Application thereof may be via spray coating, roller coating, dip coating or other methods known in the art.

In some embodiments the gel is coated on at least one side with an adhesive material for reduced dust generation. A suitable adhesive forms a coherent, flexible coating adherent to the surface of the gel. A preferred coating is porous to allow for solvent exchange during aging and extraction processes. Suitable adhesives include but are not limited to materials comprising foam adhesives, aerosol adhesives, porous polyacrylate or a combination thereof. In a preferred embodiment neoprene rubber adhesive is used to coat the gel at least on one side. Application thereof may be via spray coating, roller coating, dip coating or other methods known in the art. Preferably coating is performed on a fresh gel, before substantial aging.

The manufacture of the insulating structures of the present invention may be carried out in a continuous fashion reminiscent of that described in US patent application 2005/0046086, and U.S. Pat. No. 6,989,213 which are expressly incorporated by reference. Accordingly, a polymeric sheet with a fibrous layer affixed thereto may be fed into a continuous casting system, such as via a conveyor, where a gel precursor solution is poured into the fibrous layer. As before, the polymeric sheet is shaped to contain the solution or is placed in a container permitting the same. Optionally a coating is sprayed onto said fibrous layer. Optionally another fibrous layer affixed to a polymeric sheet is pressed into the sol solution, penetrating the excess solution. Once sufficient gelling has occurred, the resultant structure may be removed and rolled onto a mandrel, or cut to desired dimensions, stacked in plurality of layers, encapsulated, or otherwise fabricated for suitable applications in as varied applications as oil and gas pipeline insultion, LNG insulation, apparel and foot ware insulation, building insulation, automotive parts insulation, fuel cell insulation, building envelopes, aerospace insulation, acoustic insulation, and many others.

The following examples are provided to illustrate some embodiments of the present invention and therefore may not be construed as a limitation in scope of the present invention in any manner.

Tyvek® sheet(s) of desired dimensions will be sprayed with Scotchgard® adhesive on one side and glued to a lofty batting fiber layer. A silica gel precursor solution for a desired target density silica gel will be prepared, optionally comprising an opacifying compound. The Tyvek® sheets with adhered fiber layer will be placed at the bottom of a mold, or the edges of the sheet(s) will be folded to contain the solution or both. Once gelation is complete, aging will be carried out in HMDS ethanolic solution at 55° C. followed by drying via supercritical CO₂ extraction.

Tyvek® sheets of 8″×8″ and 4.5″×4.5″ are sprayed with Scotchgard® adhesive on one side. Some sheets are glued to a polyester batting fiber layer. A silica gel precursor solution for a 0.05 g/cc target density silica gel is prepared comprising carbon black. The Tyvek® sheets with adhered fiber layer are placed at the bottom of a mold. The silica gel precursor solution is poured into the fiber layer such that there is excess solution above the fiber layer. Thereafter, another fiber layer adhered to a Tyvek® Sheet is pressed gently into the excess solution. Once gelation is complete, aging is carried out in HMDS ethanolic solution at 55° C. followed by drying via supercritical CO₂ extraction. The final structure is 10 mm thick, with a density of about 0.097 g/cc and thermal conductivity of about 11.6 mW/mK. A comparison between standard fiber reinforced aerogel and the novel polymeric sided aerogel is shown in Table 1.

TABLE 1
Dust mitigation in insulating aerogel structures

| Number polymeric faces | Aerogel dust* (%) |
|---|---|
| 0 | 2.5 |
| 1 | 1.2 |
| 2 | 0.3 |

*pipe-rolling method

Double sided aerogel shows over 80% dust reduction compared to standard fiber reinforced aerogel.

The folling pipe-rolling method was used to measure dust from aerogel and is essentially a weight loss measurement before and after rolling the aerogel around a pipe. The aerogel coupon is weighed at top loading balance (Wi), then rolled over a 5″ diameter metal pipe for 10 times: 2 times on different sides of each face of the coupon, then flipping the coupon 5 times from one face to another, alternatively. After rolling, the coupon is re-weighed (Wf).The dust shed from the aerogel coupon (% Dust) is calculated as:

% Dust=(Wi−Wf)/Wi*100

What is claimed is:

1. An insulating structure comprising; at least one fibrous layer comprising a continuous matrix of an aerogel material infused therein, said at least one fibrous layer secured with an adhesive to a polymeric sheet wherein the polymeric sheet is adhered to the fibrous batting before the aerogel material is infused.

2. The structure of claim 1 wherein the fibrous layer is coated on one side.

3. The insulating structure of claim 1 wherein the fibrous layer is secured with an adhesive on at least two sides to a polymeric sheet.

4. The insulating structure of claim 1 wherein the thermal conductivity is less than about 20 mW/mK, less than 19 mW/mK, less than about 18 mW/mK, less than about 17 mW/mK, less than about 16 mW/mK, less than about 15 mW/mK, less than about 14 mW/mK, less than about 13 mW/mK or less than about 12 mW/mK.

5. The insulating structure of claim 2 wherein the fibrous layer is coated with a material comprising silicones, polyorganosiloxanes, urethanes, acrylics or a combination thereof.

6. The structure of claim 1 wherein the fibrous layer comprises organic polymer-based fibers, inorganic fibers or a combination thereof.

7. The structure of claim 1 wherein the fibrous layer comprises fibers in a woven, non-woven, mat, felt, batting, lofty batting, chopped fibers or a combination thereof.

8. The structure of claim 1 wherein the aerogel comprises an organic, inorganic or hybrid organic-inorganic material.

9. The structure of claim 1 wherein the aerogel comprises silica, titania, zirconia, alumina, hafnia, yttria, ceria, carbides, nitrides, variants of the foregoing or a combination thereof.

10. The structure of claim 1 wherein the aerogel comprises urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural, a polyether or combinations thereof.

11. The structure of claim 1 wherein the aerogel comprises silica-PMMA, silica-chitosan, silica-polyether or any combination thereof.

12. The structure of claim 1 where in the aerogel comprises an opacifying compound.

13. The structure of claim 12 wherein the opacifying compound is B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

14. The structure of claim 1 wherein the polymeric sheet comprises polyesters, polyethylenes, polypropylenes, polyacrylonitriles, polyamids, aramids, polyethyleneterphthalate, low density polyethylene, ethylene-propylene co-polymers, poly(4-methyl-pentane), polytetrafluoroethylene, poly(1-butene), polystyrene, polyvinylacetate, polyvinylchloride, polyvinylidenechloride, polyvinylfluoride, polyvinylacrylonitrile, polymethylmethacrylate, polyoxymethylene, polyphenylenesulfone, cellulosetriacetate, polycarbonate, polyethylene naphthalate, polycaprolactam, polyhexamethyleneadipamide, polyundecanoamide and polyimide.

15. A method of preparing an insulating structure comprising: providing a fibrous layer with a polymeric sheet adhered thereto; introducing a gel precursor solution onto said fibrous layer; allowing said gel precursor solution to form a gel and drying the gel.

16. The method of claim 15 wherein the gel precursor solution is gelled by introducing an amount catalyst, heat, electromagnetic energy or a combination thereof.

17. The method of claim 15 wherein the gel comprises an organic, inorganic or hybrid organic-inorganic material.

18. The method of claim 15 wherein the aerogel comprises silica, titania, zirconia, alumina, hafnia, yttria, ceria, carbides, nitrides, variants of the foregoing or a combination thereof.

19. The method of claim 15 wherein the aerogel comprises urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural, a polyether or combinations thereof.

20. The method of claim 15 wherein the aerogel comprises silica-PMMA, silica-chitosan, silica-polyether or a hybrid combining any combination thereof.

21. The method of claim 15 further comprising the step of aging and optionally treating the gel with a hydrophobic agent prior to drying.

22. The method of claim 15 comprising the step of coating at least one surface of the fibrous layer.

23. The method of claim 15 wherein the gel is dried using supercritical carbon dioxide.

24. A method of preparing an insulating structure comprising:
providing a first polymeric sheet with a first fibrous layer adhered thereto;
introducing an amount of a gel precursor solution into said fibrous layer;
providing a second polymeric sheet optionally with a second fibrous layer adhered thereto;
bringing said first fibrous layer and said second polymeric sheet together;
allowing said gel precursor solution to form a gel;
rolling the formed gel as sheets and
drying the gel sheets.

25. The method of claim 24 wherein the gel comprises an organic, inorganic or hybrid organic-inorganic material

26. The structure of claim 24 wherein the aerogel comprises silica, titania, zirconia, alumina, hafnia, yttria, ceria, carbides, nitrides or a combination thereof.

27. The structure of claim 24 wherein the aerogel comprises urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural, a polyether or combinations thereof.

28. The method of claim 24 further comprising the step of aging the gel sheet prior to drying.

29. The method of claim 24 wherein the gel sheet is dried using supercritical carbon dioxide.

30. A method of preparing an insulating structure comprising:
providing a first polymeric sheet with a first fibrous layer bonded thereto;
introducing an amount of a gel precursor solution into said fibrous layer;
coating the gel with adhesive layer;
aging the gelled structure
drying the gel.
